(19) United States
(12) Patent Application Publication
(10) Pub. No.: US 2023/0098380 A1
(43) Pub. Date: Mar. 30, 2023

(54) GRILL WITH MULTI-FUNCTIONAL THERMAL INSULATION NET

(71) Applicant: NINGBO AGSUN PRODUCTS,INC., CIXI (CN)

(72) Inventors: Xuefei Mao, CIXI (CN); Zhenpu Li, CIXI (CN); Xianghua Liu, CIXI (CN)

(73) Assignee: NINGBO AGSUN PRODUCTS,INC., CIXI, ZJ (CN)

(21) Appl. No.: 18/075,468

(22) Filed: Dec. 6, 2022

(30) Foreign Application Priority Data
Sep. 29, 2022 (CN) 202222617432.X

(51) Int. Cl. A47J 37/07

(52) U.S. Cl. CPC A47J 37/0786; A47J 37/0713

(57) ABSTRACT

The disclosure provides a grill with a multi-functional thermal insulation net, which comprises a grill body, burners provided in the grill body, and a barbecue provided on a top portion of the grill body, a gas regulating valve connected to the burners is provided on the grill body, where a support is provided on both top sides of the grill body, a thermal insulation net body is provided between the two supports, a plurality of hanging groove structures for hanging food are provided on one side of the thermal insulation net body, and a plurality of hole and groove structures for inserting food are formed on the thermal insulation net body.

### TECHNICAL FIELD

The disclosure pertains to the technical field of barbecue devices, and specifically pertains to a grill with a multi-functional thermal insulation net.

### BACKGROUND

Barbecue grills belong to barbecue equipment, and commonly used barbecue grills include charcoal grills, gas grills, electric grills, etc. The barbecue grills are usually used for grilling kebobs, seafood, vegetables, etc. A barbecue grill structurally comprises a grill body, burners and a barbecue net, the burners are located in a grill cavity of the grill body, the burners are provided with a gas regulating valve for adjusting firepower output of the burners, and the barbecue net is located above the burners, so that a user places the food to be grilled on the barbecue net for grilling.

Most of the existing barbecue grills have a thermal insulation net, and the thermal insulation net is located above the barbecue net. When the user roasts food with the grill, a bearing surface of the thermal insulation net is used for placing small-volume kebobs such as meat kebobs and vegetable kebobs; and rising heat in the grill cavity is used to insulate the kebobs placed on the thermal insulation net, which can effectively prevent the food from cooling or burning. However, the existing thermal insulation net has relatively single function. For example, conical and cylindrical food such as drumsticks, pork trotters and green peppers can only be placed on the bearing surface of the thermal insulation net, and due to large volume of such food and insufficient contact between the top of the food and heat, the user still needs to turn the food one by one, increasing the workload of the user and reducing user experience.

### SUMMARY

The object of the disclosure is to design a grill with a multi-functional thermal insulation net in order to solve the above-mentioned technical deficiencies. The disclosure enables food to be vertically placed on the thermal insulation net body by adding hanging and inserting function, so that rising heat in the grill body is in sufficient contact with the food, reducing workload of a user, and the user can also increase firepower to heat the food on the thermal insulation net body, enriching fun of the grill and improving user experience.

In order to solve the above-mentioned technical problem, the technical scheme of the present disclosure is as follows: an grill with a multi-functional thermal insulation net comprises a grill body, burners provided in the grill body, and a barbecue provided on a top portion of the grill body, a gas regulating valve connected to the burners is provided on the grill body, a support is provided on both top sides of the grill body, a thermal insulation net body is provided between the two supports, a plurality of hanging groove structures for hanging food are provided on one side of the thermal insulation net body, and a plurality of hole and groove structures for inserting food are formed on the thermal insulation net body.

Preferably, the thermal insulation net body comprises two transverse strips and a plurality of longitudinal frames, both ends of the longitudinal frames are respectively fixedly connected to the two transverse strips, and the plurality of longitudinal frames are uniformly distributed along a length direction of the transverse strips.

Preferably, inserting columns are provided at both end bottom portions of the transverse strips, and insertion holes for inserting the inserting columns are provided through top portions of the supports.

Preferably, the thermal insulation net body further comprises a reinforcing strip, the hanging groove structures are formed at one end of the longitudinal frame, connecting portions are provided at end portions of the longitudinal frames away from the hanging groove structures, and each of the connecting portions is fixedly connected to the reinforcing strip.

Preferably, a wind deflector is provided at the top portion of the grill body corresponding to a position between the two supports, a guide plate is bent inwards at a top portion of the wind deflector, and the reinforcing strip is located at the guide plate.

Preferably, the hanging groove structures and the longitudinal frames are provided in a bent state, and an included angle between the hanging groove structures and the longitudinal frames is an obtuse angle.

Preferably, the longitudinal frames each comprise a first connecting strip and a second connecting strip, the first connecting strip and the second connecting strip are fixedly connected by the hanging groove structures, the connecting portions are provided at end portions of the first connecting strip and the second connecting strip, and the connecting portions are in a vertical state.

Preferably, the hole and groove structures each comprise a first half-ring portion and a second half-ring portion provided symmetrically, the first half-ring portion is located on the first connecting strip and bent outwards, and the second half-ring portion is located on the second connecting strip and bent outwards.

The disclosure has the following beneficial effects: heat generated by the burners rises in the grill body and successively passes through the barbecue and the thermal insulation net body; a user can place small-volume kebobs such as meat kebobs and vegetable kebobs on the barbecue for grilling, place the grilled kebobs on a bearing surface of the thermal insulation net body, and use the rising heat to perform thermal insulation; large-volume conical and cylindrical food such as drumsticks, pork trotters and green peppers can be hung on the hanging groove structures or inserted into the hole and groove structures, so that the food stands upright on the thermal insulation net body; the top of the food is close to the thermal insulation net body and is close to the barbecue, and the rising heat is in sufficient contact with the food, providing good thermal insulation, releasing the user from turning the food, and reducing workload of the user. In addition, the user can also increase firepower output of the burners through the gas regulating valve to heat the food on the thermal insulation net body, so that the thermal insulation net body is used as a barbecue tool with hanging and grilling function added, enriching fun of the grill and improving user experience.

### BRIEF DESCRIPTION OF THE DRAWINGS

FIG. 1 is a schematic structural diagram of an embodiment;

FIG. 2 is a cross-sectional view of the embodiment; and

FIG. 3 is a schematic structural diagram of a thermal insulation net body.

Reference numerals in the drawings: 1. grill body; 2. burner; 3. barbecue; 4. gas regulating valve; 5. igniter; 6. support; 7. thermal insulation net body; 71. transverse strip; 72. longitudinal frame; 721. first connecting strip; 722. second connecting strip; 73. reinforcing strip; 8. hanging groove structure; 9. hole and groove structure; 91. first half-ring portion; 92. second half-ring portion; 10. inserting column; 11. insertion hole; 12. connecting portion; 13. wind deflector; 14. guide plate.

### DESCRIPTION OF THE EMBODIMENTS

The disclosure will be further described in the following embodiments with reference to the accompanying drawings.

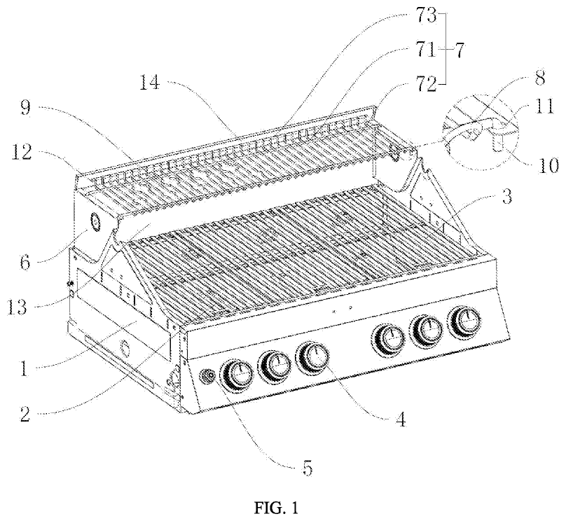

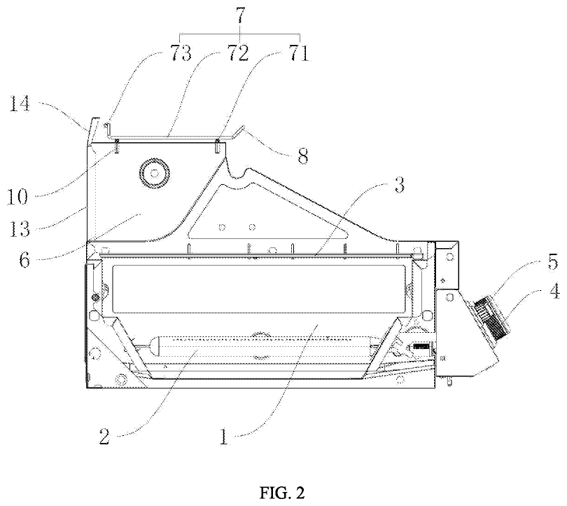

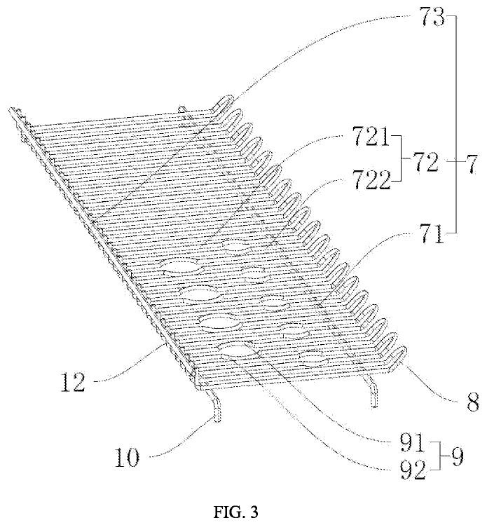

With reference to FIGS. 1, 2 and 3, an grill with a multi-functional thermal insulation net comprises a grill body 1, burners 2 provided in the grill body 1, and a barbecue 3 provided on a top portion of the grill body 1, a gas regulating valve 4 connected to the burners 2 is provided on the grill body 1, there are a plurality of burners 2, the plurality of burners 2 are uniformly distributed along a length direction of the grill body 1, the burners 2 are linear burner tubes, top portions of the burner tubes are provided with a fire outlet hole respectively, the grill body 1 is provided with an igniter 5, and a user can ignite each burner 2 by the igniter 5. The burners 2 ignite a mixture of gas and air for combustion, thereby generating heat, and the gas regulating valve 4 is used to control flow rate of gas input into the burners 2, thereby controlling output firepower of the burners 2. The gas regulating valve 4, the burners 2 and the igniter 5 are all prior art and will not be described in detail herein. The barbecue 3 is a met structure, the barbecue 3 is located above the burners 2, and the user can place food on the barbecue 3 to perform barbecue operation.

A support 6 is provided on both top sides of the grill body 1, a wind deflector 13 is fixedly connected to one side of the top portion of the grill body 1 away from the gas regulating valve 4, two sides of the wind deflector 13 are respectively fixedly connected to the two supports 6 to improve impact resistance of the wind deflector 13, and the wind deflector 13 is used for blocking wind and reducing influence of the wind on combustion efficiency of the burners 2.

A thermal insulation net body 7 is provided between the two supports 6, the thermal insulation net body 7 is located above the barbecue 3, the thermal insulation net body 7 comprises two transverse strips 71, a plurality of longitudinal frames 72 and a reinforcing strip 73, inserting columns 10 are provided at both end bottom portions of the transverse strips 71, insertion holes 11 for inserting the inserting columns 10 are provided through top portions of the supports 6, so that the user can assemble and disassemble the thermal insulation net body 7 on the two supports 6, and after the grill is used, the user can remove the thermal insulation net body 7 for cleaning and maintenance.

Both ends of the longitudinal frames 72 are respectively fixedly connected to two transverse strips 71, and the plurality of longitudinal frames 72 are uniformly distributed along a length direction of the transverse strips 71, so that the thermal insulation net body 7 is of a net structure; the user can place the food on a bearing surface of the thermal insulation net body 7; heat generated by the burners 2 rises in the grill body 1 and passes through the barbecue 3 and the thermal insulation net body 7 successively, and the rising heat in the grill body 1 is used to perform thermal insulation on the food.

A plurality of hanging groove structures 8 for hanging food are provided on one side of the thermal insulation net body 7 away from the wind deflector 13, and a plurality of hole and groove structures 9 for inserting food are formed on the thermal insulation net body 7. The user can place small-volume kebobs such as meat kebobs and vegetable kebobs on the barbecue 3 for grilling, and place the grilled kebobs on the bearing surface of the thermal insulation net body 7. Large-volume conical and cylindrical food such as drumsticks, pork trotters and green peppers can be hung on the hanging groove structures 8 or inserted into the hole and groove structures 9, so that the food stands upright on the thermal insulation net body 7. The distance between the food standing upright on the thermal insulation net body 7 and the barbecue 3 is relatively short, and the rising heat is in sufficient contact with the food, providing good thermal insulation, releasing the user from turning the food, and reducing workload of the user. In addition, the user can also increase firepower output of the burners 2 through the gas regulating valve 4 to heat the food on the thermal insulation net body 7, so that the thermal insulation net body 7 is used as a barbecue tool with hanging and grilling function added, enriching fun of the grill and improving user experience.

The hanging groove structures 8 structurally correspond to the longitudinal frames 72 respectively; the hanging groove structures 8 are of a wave shape; the longitudinal frames 72 each comprise a first connecting strip 721 and a second connecting strip 722 provided symmetrically; the first connecting strip 721 and the second connecting strip 722 are fixedly connected by the hanging groove structures 8, so that the longitudinal frames 72 are of a U-shaped structure; the hanging groove structures 8 and the longitudinal frames 72 are provided in a bent state; and an included angle between the hanging groove structures 8 and the longitudinal frames 72 is an obtuse angle, so that when the user hangs the food in the hanging groove structures 8, it is possible to prevent the food from falling out of the hanging groove structures 8.

Connecting portions 12 are provided at end portions of the first connecting strip 721 and the second connecting strip 722 away from the hanging groove structures 8 in a vertically bent state, and each of the connecting portions 12 is fixedly connected to the reinforcing strip 73 so as to enhance structural strength of the thermal insulation net body 7. A guide plate 14 is bent inwards at a top portion of the wind deflector 13, the reinforcing strip 73 is located at the guide plate 14, and the guide plate 14 is used to prevent wind from blowing towards the bearing surface of the thermal insulation net body 7, so as to prevent the wind from reducing the heat around the thermal insulation net body 7 which results in gradual cooling of the food and affects the taste.

A plurality of hole and groove structures 9 are formed on some of the longitudinal frames 72 of the thermal insulation net body 7; the plurality of hole and groove structures 9 are uniformly distributed along a length direction of the transverse strips 71; two adjacent hole and groove structures 9 are provided in a staggered manner; the hole and groove structures 9 comprise a first half-ring portion 91 and a second half-ring portion 92 provided symmetrically; the first half-ring portion 91 is located on the first connecting strip 721 and bent outwards; and the second half-ring portion 92 is located on the second connecting strip 722 and bent outwards, facilitating the user to insert the conical and cylindrical food between the corresponding first half-ring portion 91 and second half-ring portion 92. The food inserted into the hole and groove structures 9 can also be securely clamped by deformation stress of the corresponding longitudinal frames 72.

Of course, the above describes typical embodiments of the disclosure only. In addition, the disclosure can also have various other implementations, and all technical schemes formed by equivalent replacement or equivalent transformation fall within the scope of protection of the disclosure.

What is claimed is:

1. A grill with a multi-functional thermal insulation net, comprising a grill body, burners provided in the grill body, and a barbecue provided on a top portion of the grill body, wherein a gas regulating valve connected to the burners is provided on the grill body, a support is provided on both top sides of the grill body, an thermal insulation net body is provided between the two supports, a plurality of hanging groove structures for hanging food are provided on one side of the thermal insulation net body, and a plurality of hole and groove structures for inserting food are formed on the thermal insulation net body.

2. The grill according to claim 1, wherein the thermal insulation net body comprises two transverse strips and a plurality of longitudinal frames, both ends of the longitudinal frames are respectively fixedly connected to the two transverse strips, and the plurality of longitudinal frames are uniformly distributed along a length direction of the transverse strips.

3. The grill according to claim 2, wherein inserting columns are provided at both end bottom portions of the transverse strips, and insertion holes for inserting the inserting columns are provided through top portions of the supports.

4. The grill according to claim 2, wherein the thermal insulation net body further comprises a reinforcing strip, the hanging groove structures are formed at one end of the longitudinal frame, connecting portions are provided at end portions of the longitudinal frames away from the hanging groove structures, and each of the connecting portions is fixedly connected to the reinforcing strip.

5. The grill according to claim 4, wherein a wind deflector is provided at the top portion of the grill body corresponding to a position between the two supports, a guide plate is bent inwards at a top portion of the wind deflector, and the reinforcing strip is located at the guide plate.

6. The grill according to claim 4, wherein the hanging groove structures and the longitudinal frames are provided in a bent state, and an included angle between the hanging groove structures and the longitudinal frames is an obtuse angle.

7. The grill according to claim 4, wherein the longitudinal frames each comprise a first connecting strip and a second connecting strip, the first connecting strip and the second connecting strip are fixedly connected by the hanging groove structures, the connecting portions are provided at end portions of the first connecting strip and the second connecting strip, and the connecting portions are in a vertical state.

8. The grill according to claim 7, wherein the hole and groove structures each comprise a first half-ring portion and a second half-ring portion provided symmetrically, the first half-ring portion is located on the first connecting strip and bent outwards, and the second half-ring portion is located on the second connecting strip and bent outwards.
